(19) United States
(12) Patent Application Publication
(10) Pub. No.: US 2022/0098962 A1
(43) Pub. Date: Mar. 31, 2022

(54) WEAR AND CORROSION RESISTANT STEEL COMPOSITIONS AND HIGH PRESSURE PUMPS AND PUMP COMPONENTS COMPRISED THEREOF

(71) Applicant: SPM Oil & Gas Inc., Fort Worth, TX (US)

(72) Inventors: Jacob Bayyouk, Richardson, TX (US); Alastair Scott Pearson, Glasgow (GB); Frank Hippenstiel, Siegen (DE); Michael Muller, Freudenberg (DE)

(21) Appl. No.: 17/549,769

(22) Filed: Dec. 13, 2021

Related U.S. Application Data
(63) Continuation of application No. PCT/US2020/038518, filed on Jun. 18, 2020.
(60) Provisional application No. 62/864,932, filed on Jun. 21, 2019.

(51) Int. Cl. E21B 43/26; F04B 19/04; F04B 53/00; F04B 53/10; F04B 53/14; F04B 53/16; C22C 38/50; C22C 38/48; C22C 38/46; C22C 38/44; C22C 38/06; C22C 38/02; C22C 38/04; C22C 38/00

(52) U.S. Cl. CPC E21B 43/26; C22C 38/001; F04B 53/006; F04B 53/007; F04B 53/10; F04B 53/14; F04B 53/16; C22C 38/50; C22C 38/48; C22C 38/46; C22C 38/44; C22C 38/06; C22C 38/02; C22C 38/04; C22C 38/002; F04B 19/04

(57) ABSTRACT

The present disclosure relates, according to some embodiments, to a resistant steel composition including a nickel content from about 1.75% MB to about 5.75% MB. Further, the present disclosure relates to a fluid end block assembly for use in a plunger pump apparatus, the fluid end assembly including: at least one cylinder body configured to receive a respective plunger from a power end; at least one suction bore configured to house a valve body, a valve seat, a spring; a spring retainer, with at least one of the cylinder body, the suction bore, and the spring retainer being composed of a steel composition having a nickel content from about 1.75% MB to about 5.75% MB.

### CROSS-REFERENCE TO RELATED APPLICATIONS

This application is a continuation of and claims priority to International Application No. PCT/US2020/038518, filed on Jun. 18, 2020, titled “Wear and Corrosion Resistant Steel Compositions and High Pressure Pumps and Pump Components Comprised Thereof,” which claims priority to U.S. Provisional Application No. 62/864,932 filed on Jun. 21, 2019, both of which are incorporated by reference in their entirety for all purposes.

### FIELD OF THE DISCLOSURE

The present disclosure relates, in some embodiments, to wear and corrosion resistant steel compositions (i.e., a resistant steel composition). In some embodiments, the disclosure relates to high pressure pumps and pump components comprised of a resistant steel composition (e.g., a fluid end assembly of a hydraulic fracturing pump).

### BACKGROUND

Hydraulic fracturing is an oil well stimulation technique in which bedrock is fractured (i.e., fracked) by the application of a pressurized fracking fluid. The effectiveness of fracking fluid is due not only to pressurization, but also to its composition of one or more proppants (e.g., sand) and chemical additives (e.g., dilute acids, biocides, breakers, pH adjusting agents). The application of pressurized fracking fluid to existing bedrock fissures creates new fractures in the bedrock, as well as, increasing the size, extent, and connectivity of existing fractures. This permits more oil and gas to flow out of the rock formations and into the wellbore, from where they can be extracted.

Hydraulic fracturing pumps generally consist of a power end assembly and a fluid end assembly, with the power end assembly pressurizing a fracking fluid to generate a pressurized fluid and the fluid end assembly directing the pressurized fluid into the wellbore through a series of conduits. Hydraulic fracking pump components (e.g., a fluid end assembly) that are exposed to fracking fluid are prone to fluid leakage, failure, and other sustainability issues due to wear, corrosion, and degradation resulting from their exposure to components of the fracking fluid having corrosive or abrasive properties (e.g., proppant, chemical additives). As a result hydraulic fracking pump components require frequent replacement at a substantial cost.

The composition of hydraulic pump components plays a large role in both the frequency of replacement and cost. While pump components composed of stainless steel have a life span of around 2000 working hours, the exorbitant cost of stainless steel often makes their use cost prohibitive. By contrast, pump components composed of carbon steel alloy offer an inexpensive price point, but have a life span of only about 10-15% compared to their stainless steel counterparts (i.e., 200-300 working hours). Accordingly, there is a need for hydraulic pump components that are both resistant to abrasion and corrosion—providing an advanced working life span—and available at an affordable price point.

### SUMMARY

The present disclosure relates, according to some embodiments, to a resistant steel composition having a nickel content from about 1.75% mass basis (MB) to about 5.75% MB. In some embodiments, a resistant steel composition may have a nickel content from about 2.0% MB to about 4.1% MB. A resistant steel composition may exhibit from about 5% less to about 50% less pitting in comparison to a carbon alloy steel counterpart when exposed to a corrosive. A resistant steel composition may exhibit an average lifespan that ranges from at least 10% longer to at least 500% longer than that of a carbon steel alloy counterpart when exposed to a fracking fluid.

In some embodiments, a resistant steel composition may include one or more of a carbon content from about 0.07% MB to about 0.17% MB; a manganese content from about 0.3% MB to about 0.6% MB; and a chromium content from about 8% MB to about 10% MB. A resistant steel composition may include one or more of a copper content of less than about 0.5% MB; a sulfur content of less than about 0.02% MB; and a silicon content of less than about 1% MB. According to some embodiments, a resistant steel composition may include a phosphorous content of less than about 0.04% MB; a molybdenum content from about 0.5% MB to about 2% MB; and a niobium content from about 0.01% MB to about 0.1% MB. A steel composition may include a vanadium content from about 0.01% MB to about 0.1% MB; a titanium content from about 0.0001% MB to about 0.1% MB; a nitrogen content from about 0.02% MB to about 0.07% MB; and an aluminum content of less than about 0.1% MB.

According to some embodiments, the present disclosure relates to a hydraulic fracturing pump including a fluid end assembly. A fluid end assembly may include a cylinder body, a suction bore, and a spring retainer. A cylinder body may be configured to receive a respective plunger from a power end assembly. A suction bore may be configured to house a valve body, a valve seat, and a spring. In some embodiments, one or more of a cylinder body, a suction bore, and a spring retainer may include a steel composition having a nickel content from about 1.75% MB to about 5.75% MB. A fluid end assembly may be grooveless. A hydraulic fracturing pump may include a suction cover configured to fit into a suction bore and a valve stop that is attached to the suction cover through a stem, the valve stop configured to lock under a ridge in the fluid cylinder bore. A suction bore may include one or more grooves. A hydraulic fracturing pump may include a wing style valve stop configured to lock in place through a groove.

In some embodiments, the present disclosure relates to a hydraulic fracturing pump including a fluid end assembly and a power end assembly. A power end assembly includes a crank shaft; a frame; a connecting rod connected to the crank shaft; a cross head; and a plunger connected to the connecting rod. One or more of a crank shaft, a frame, a connecting rod, a cross head, and a plunger includes a resistant steel composition having a nickel content from about 1.75% MB to about 5.75% MB.

### BRIEF DESCRIPTION OF THE DRAWINGS

Exemplary embodiments of the present disclosure are described herein with reference to the drawings, wherein like parts are designated by like reference numbers, and wherein:

FIG. 1 illustrates a cross-sectional perspective of a general hydraulic fracturing pump;

FIG. 2 illustrates pitting on a metal component of a hydraulic fracturing pump caused by exposure to high pressure fluid containing abrasive and corrosive components;

FIG. 3 illustrates a front perspective of a hydraulic fracturing pump, according to a specific example embodiment of the disclosure;

FIG. 4A illustrates a front perspective of a grooveless fluid end assembly having a valve stop design that locks under a ridge in the fluid cylinder bore, according to a specific example embodiment of the disclosure; and

FIG. 4B illustrates a front perspective of a fluid end assembly having a grooved suction bore to lock the valve stop in place, according to a specific example embodiment of the disclosure.

### DETAILED DESCRIPTION

The present disclosure relates, to steel compositions having increased resistance to wear or corrosion when compared to a carbon alloy steel counterpart (i.e., a resistant steel composition). Moreover, the present disclosure relates to a resistant steel composition having a lower manufacturing cost than a stainless steel counterpart having similar wear or corrosion properties. In some embodiments, the present disclosure relates to a resistant steel composition having increased resistance to wear or corrosion when compared to a carbon steel alloy counterpart and having a manufacturing cost sufficiently lower than a stainless steel counterpart such that the combination of properties is desirable.

As illustrated in Table 1, a carbon steel alloy is defined by its main alloying ingredient of carbon and its properties are predominantly dependent upon the percentage of carbon present. As carbon percentages rise, a carbon alloy steel has increased hardness and reduced ductility. Carbon alloy steel is ordinarily grouped into three categories: low carbon steel including between 0.05% and 0.3% MB carbon, medium carbon steel including between 0.3% and 0.8% MB carbon, and high carbon steel including between 0.8% MB and 2% MB carbon. Although the primary element of interest is carbon, a carbon alloy steel may also include by mass, a manganese content from 0.75% MB to 1.75% MB, a nickel content of 0.25% MB, a copper content of less than 0.6% MB, a sulfur content from 0.25% MB to 0.35% MB, a silicon content from 0.1% MB to 2.2% MB, and an aluminum content from 0.06% MB to 1.25% MB, a phosphorous content from 0.04% MB to 0.09% MB, a molybdenum content of less than 0.01% MB, a niobium content of less than 0.01% MB, a vandium content of less than 0.01% MB, a titanium content of less than 0.01% MB, a nitrogen content from 0.02% MB to 0.07% MB, and any combination thereof. A carbon alloy steel ordinarily includes only trace amounts of chromium. Carbon alloy steel is susceptible to wear and corrosion, particularly when exposed to corrosive materials such as a fracking fluid. A carbon alloy steel component (e.g., a fluid end assembly composed of carbon alloy steel) may have a life span of up to 100 hours, or up to 150 hours, or up to 200 hours, or up to 250 hours, or up to 300 hours.

By contrast, a stainless steel includes a low carbon content of 0.03% to 0.15% MB and high levels of chromium, ordinarily ranging from 11% to 30% MB. The high chromium content of stainless steel contributes to its high manufacturing cost. A stainless steel may have varying levels of other elements including copper, manganese, nickel, molybdenum, titanium, niobium, nitrogen, sulfur, phosphorus, and selenium, depending upon the specific properties desired. Typically only trace levels of aluminum are present in stainless steel. This is shown in Table 1 wherein stainless steel has, by mass: a carbon content from 0.03% MB to 0.15% MB, a silicon content from 0.75% MB to 1% MB, a sulfur content from 0.01% MB to 0.03% MB, a nickel content from 10.5% MB to 28% MB, a manganese content from 2.0% MB to 7.5% MB, a phosphorous content of less than 0.06% MB, a nitrogen content of less than 0.2% MB, and a chromium content from 11% MB to 30% MB. No minimum content of copper, molybdenum, niobium, vanadium, titanium, and aluminum is specified or required for the stainless steel. Table 1 provides an example of a stainless steel composition, but should not be construed as limiting.

Stainless steel is highly resistant to corrosion and wear, even upon exposure to corrosive materials such as a fracking fluid. A stainless steel component (e.g., a fluid end assembly composed of carbon alloy steel) may have a life span of at least 1,800 hours, or at least 1,900 hours, or at least 2,000 hours, or at least 2,100 hours, or at least 2,200 hours.

The present disclosure relates to wear and corrosion resistant steel compositions (i.e., a resistant steel composition) including a nickel composition ranging from about 1.75% mass basis (MB) to about 5.75% MB nickel, by mass, with “about,” as used in this sentence being plus or minus 0.25% MB. In some embodiments, a resistant steel composition may include a nickel composition ranging from about 2.0% MB to about 4.1% MB.

Table 2 contains resistant steel compositions according to disclosed embodiments. Disclosed steel compositions are not limited to those listed in Table 1, but instead include compositions having elements at various concentrations. According to some embodiments, a resistant steel compositions may comprise a carbon content from 0.05% MB to 0.3% MB. For example, a resistant steel composition may have a carbon content of about 0.07% MB to about 0.17% MB, with “about” as used in this sentence being plus or minus 0.01% MB. A resistant steel composition may include a manganese content from about 0.3% MB to about 0.6% MB, with “about,” as used in this sentence being plus or minus 0.1% MB. In some embodiments, a resistant steel composition may include a chromium content from about 8% MB to about 10% MB, with “about” as used in this sentence being plus or minus 1% MB. A resistant steel composition, may include a copper content of at most about 0.5% MB, with “about” as used in this sentence being plus or minus “0.05%.” For example, in some embodiments, a resistant steel composition may include a copper content in a range of about 0.01% MB to 0.05% MB, or 0.01% MB to 0.5%, or 0.05% MB to 0.5%, or about 0.01% MB to 0.5% MB. In some embodiments, a resistant steel composition may include a sulfur content of less than about 0.02% MB, with “about” as used in this sentence being plus or minus “0.005%.” For example, a resistant steel composition may include a sulfur content of 0% MB, or 0.005% MB, or 0.01% MB, or 0.015% MB, or 0.02% MB. A resistant steel composition may include a silicon content of less than about 1% MB, with “about” as used in this sentence being plus or minus 0.5% MB. For example, a resistant steel composition may include a silicon content of 0% MB, or 0.25% MB, or 0.5% MB, or 0.75% MB, or 1% MB. According to some embodiments a resistant steel composition may include an aluminum content of less than about 0.1% MB, with “about” as used in this sentence being plus or minus 0.005% MB. For example, a resistant steel composition may include an aluminum content of 0% MB, or 0.005% MB, or 0.01% MB, or 0.02% MB, or 0.03% MB, or 0.04% MB, or 0.05% MB, or 0.06% MB, or 0.07% MB, or 0.08% MB, or 0.09% MB, or 0.1% MB. A resistant steel composition may include a phosphorous content of less than about 0.04% MB, with “about” as used in this sentence being plus or minus 0.01% MB. For example, a resistant steel composition may include a phosphorous content of 0% MB, or 0.01% MB, or 0.02% MB, or 0.03% MB, or 0.04% MB. A resistant steel composition may include a molybdenum content of from about 0.5% MB to about 2% MB, with “about” as used in this sentence being plus or minus 0.1% MB. For example, a resistant steel composition may include a molybdenum content of 0.5% MB, or 0.1% MB, or 1.5% MB, or 2% MB.

A resistant steel composition may include a niobium content from about 0.01% MB to about 0.1% MB, with “about” as used in this sentence being plus or minus 0.005% MB. For example, a resistant steel composition may include a niobium content of 0.01% MB, or 0.025% MB, or 0.05% MB, or 0.075% MB, or 0.1% MB. A resistant steel composition may include a vanadium content from about 0.01% MB to about 0.1% MB, with “about” as used in this sentence being plus or minus 0.01% MB. For example, a resistant steel composition may include a vandium content of 0.01% MB, or 0.025% MB, or 0.05% MB, or 0.075% MB, or 0.1% MB. A resistant steel composition may include a vanadium content from about 0.01% MB to about 0.1% MB, with “about” as used in this sentence being plus or minus 0.01% MB. For example, a resistant steel composition may include a vandium content of 0.01% MB, or 0.025% MB, or 0.05% MB, or 0.075% MB, or 0.1% MB. A resistant steel composition may include a titanium content from about 0.0001% MB to about 0.1% MB, with “about” as used in this sentence being plus or minus 0.01% MB. For example, a resistant steel composition may include a titanium content of 0.0001% MB, or 0.025% MB, or 0.05% MB, or 0.075% MB, or 0.1% MB. A resistant steel composition may include a nitrogen content from about 0.02% MB to about 0.07% MB, with “about” as used in this sentence being plus or minus 0.01% MB. For example, a resistant steel composition may include a nitrogen content of 0.02% MB, or 0.04% MB, or 0.05% MB, or 0.06% MB, or 0.07% MB.

TABLE 1
Elemental Compositions of Various Steels

| Composition | C | Mn | Cr | Ni | Cu | S | Si | Al |
|---|---|---|---|---|---|---|---|---|
| Resistant Steel | 0.07-0.17 | 0.3-0.6 | 8-10 | 1.75-5.75 | <0.5 | <0.02 | <1 | <0.1 |
| Composition | | | | | | | | |
| Carbon Steel | 0.05-0.3 | 0.75-1.75 | trace | 0.25 | <0.6 | 0.2 | 0.1-2.2 | 0.06-1.25 |
| | (low) | | | | | | | |
| | 0.3-0.8 | | | | | | | |
| | (medium) | | | | | | | |
| | 0.8-2 | | | | | | | |
| | (high) | | | | | | | |
| Stainless Steel | 0.03-0.15 | 2-7.5 | 11-30 | 10.5-28 | — | 0.01-0.03 | 0.75-1 | — |

| Composition | P | Mo | Nb | V | Ti | N |
|---|---|---|---|---|---|---|
| Resistant Steel | <.04 | 0.5-2 | 0.01-0.1 | 0.01-0.1 | 0.0001-0.1 | 0.02-0.07 |
| Composition | | | | | | |
| Carbon Steel | 0.04-0.09 | <0.01 | <0.01 | <0.01 | <0.01 | 0.02-0.07 |
| Stainless Steel | <.06 | — | — | — | — | 0.2 |

*All values are provided as mass basis (MB).

TABLE 2
Resistant Steel Compositions

| Composition | C | Mn | Cr | Ni | Cu | S | Si | Al | P | Mo | Nb | V | Ti | N |
|---|---|---|---|---|---|---|---|---|---|---|---|---|---|---|
| 1 | 0.17 | 0.45 | 9 | 1.7 | 0.5 | 0.02 | 0.8 | 0.1 | .023 | .6 | .08 | .016 | .01 | .016 |
| 2 | 0.125 | 0.6 | 8.2 | 1.8 | 0.25 | 0.02 | 1 | 0.03 | .05 | 1.4 | .07 | .06 | .0001 | .025 |
| 3 | 0.15 | 0.54 | 9.1 | 1.75 | 0.1 | 0.01 | 1 | 0.04 | .04 | 1.2 | .01 | .01 | .05 | 0.6 |
| 4 | 0.115 | 0.41 | 9.3 | 2.5 | 0.08 | 0.001 | 0.37 | 0.005 | .016 | 1 | .046 | .028 | .001 | .045 |
| 5 | 0.13 | 0.3 | 8.5 | 5.75 | 0.2 | 0.015 | 0.5 | 0.03 | .015 | .8 | .1 | .04 | .005 | .07 |
| 6 | 0.07 | 0.4 | 10 | 4.5 | 0.1 | 0.01 | 0.9 | 0.08 | .01 | 2 | .06 | .05 | .1 | .055 |

*All values are provided as mass basis (MB).

A resistant steel composition may have enhanced wear resistance, corrosion resistance, or a combination thereof when compared to a carbon alloy steel. In some embodiments, a resistant steel composition may have an extended life span when compared to a carbon steel alloy. For example, a resistant steel composition when compared to a carbon steel alloy exposed to the same conditions may have an average lifespan that is at least 10% longer, at least 25% longer, or at least 50% longer, or at least 100% longer, or at least 125% longer, or at least 150% longer, or at least 200% longer, or at least 250% longer, or at least 300% longer, or at least 350% longer, or at least 400% longer, or at least 450% longer, or at least 500% longer than that of its carbon steel alloy counterpart. In some embodiments, a resistant steel exhibits an average lifespan that ranges from at least 10% longer to at least 500% longer than that of a carbon steel alloy counterpart when exposed to a fracking fluid or components of the fracking fluid.

According to some embodiments, a hydraulic fracturing pump having one or more components made of a disclosed resistant steel composition may have an average lifespan that is from at least 10% longer to at least 500% longer, in comparison to a counterpart hydraulic fracturing pump having one or more components made of a carbon steel alloy.

A resistant steel composition may exhibit less pitting (indicative of corrosion) compared to a carbon steel alloy exposed to the same conditions. For example, a resistant steel composition may exhibit at least 5%, or at least 10%, or at least 15%, or at least 20%, or at least 25%, or at least 30%, or at least 35%, or at least 40%, or at least 45%, or at least 50% less pitting compared to its carbon alloy steel counterpart. According to some embodiments, a hydraulic fracturing pump having one or more components made of a disclosed resistant steel composition may exhibit from at least 5% to at least 50% less pitting, in comparison to a counterpart hydraulic fracturing pump having one or more components made of a carbon steel alloy.

In some embodiments, a corrosive may include a fracking fluid, an acid, a base, and a combination thereof. A corrosive may include an acid including at least one of hydrochloric acid, a sulfuric acid, a nitric acid, a chromic acid, an acetic acid, and a hydrofluoric acid. In some embodiments, a corrosive includes a base including an ammonium hydroxide, a potassium hydroxide, a sodium hydroxide, and combinations thereof. According to some embodiments, pitting may be caused at least in part by a response to exposure to a particle (e.g., sand) having a size ranging from about 1 micron to about 3,000 microns, or larger. A particle may have a size of about 1 micron, or about 10 microns, or about 20 microns, or about 30 microns, or about 40 microns, or about 50 microns, or about 60 microns, or about 70 microns, or about 80 microns, or about 90 microns, or about 100 microns, where about includes plus or minus 5 microns. A particle may have a size of about 100 microns, or about 300 microns, or about 600 microns, or about 900 microns, or about 1,200 microns, or about 1,500 microns, or about 1,800 microns, or about 2,100 microns, or about 2,400 micron, or about 2,700 microns, or about 3,000 microns, where about includes plus or minus 150 microns.

A resistant steel composition may exhibit an average lifespan, less pitting, or a combination thereof compared to a carbon alloy steel counterpart.

A resistant steel composition may have a manufacturing cost that is less than a stainless steel counterpart. For example, a resistant steel composition may have a manufacturing cost that is at least 5% less, or at least 10% less, or at least 15% less, or at least 20% less, or at least 30% less, or at least 40% less, or at least 50% less, or at least 60% less than a stainless steel composition having comparable life span and/or resistance characteristics. According to some embodiments, a hydraulic fracturing pump having one or more components made of a disclosed resistant steel composition may have a manufacturing cost that is from at least 5% less to at least 60% less, in comparison to a counterpart hydraulic fracturing pump having one or more components made of a stainless steel composition.

In some embodiments, a resistant steel composition may have a manufacturing cost that is at least at least 5% less, or at least 10% less, or at least 15% less, or at least 20% less, or at least 30% less, or at least 40% less, or at least 50% less, or at least 60% less than a stainless steel composition when factored as a cost per average working hour.

According to some embodiments, a hydraulic fracturing pump having one or more components made of a disclosed resistant steel composition may have a manufacturing cost that is from at least 5% less to at least 60% less, in comparison to a counterpart hydraulic fracturing pump having one or more components made of a stainless steel composition, when factored as a cost per average working hour. For example, if a stainless steel composition has a lifespan of 2000 working hours at a cost of $3 USD per pound. The cost of the stainless steel composition is $0.0015 per working hour.

In some embodiments, a resistant steel composition may have a decreased eutectoid reaction when compared to its carbon steel alloy counterpart.

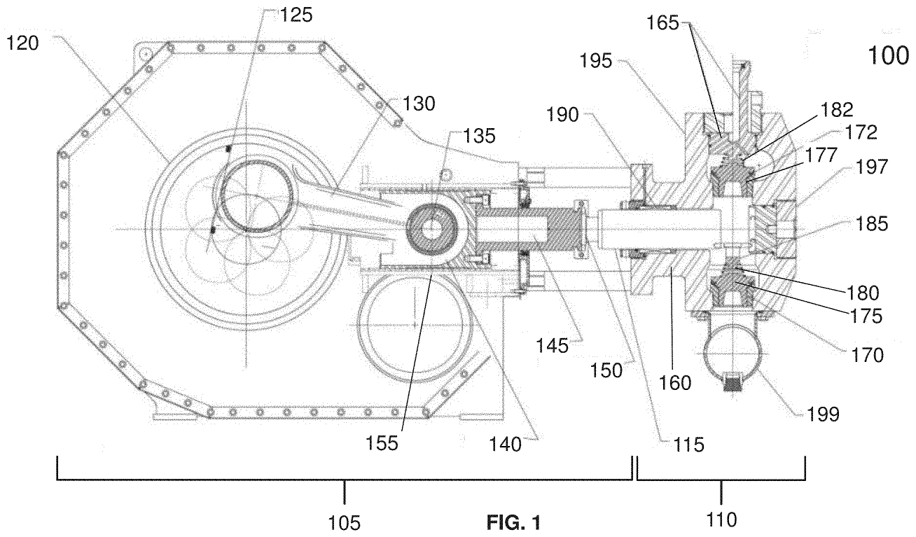

The present disclosure further relates to hydraulic fracturing pumps and pump components composed of a resistant steel composition. FIG. 1 illustrates the basic components of a hydraulic fracturing pump 100. In general, hydraulic fracturing pumps 100 are made up of a power end assembly 105 and a fluid end assembly 110. The power end assembly 105 drives reciprocating motion of plungers 115 and the fluid end assembly 110 directs the flow of fracking fluid from the pump to conduits leading to the wellbore. As shown in FIG. 1, the basic power end assembly 105 components include a frame 120, a crank shaft 125, a connecting rod 130, a wrist pin 135, a crosshead 140, a crosshead case 155, a pony rod 145, a pony rod clamp 150, and a plunger 115.

As disclosed in FIG. 1, the crankshaft 125, while contained within a frame 120, is rotated by a power source such as an engine. One or more connecting rods 130 have ends that are rotatably mounted to the crankshaft 125, wherein the opposite end of each connecting rod 130 is pivotally connected to a crosshead 140. The rotary motion of the crankshaft 125 is converted to linear motion by the crosshead 140. Each crosshead 140 is reciprocally carried within a stationary crosshead case 155. The pony rod 145 is attached to an end of the crosshead 140 that is opposite to the crank shaft 125. The plunger 115 is mounted to an end of the pony rod 145 by a pony rod clamp 150. The pony rod 145 moves, or strokes, the plunger 115 within a cylinder of a fluid end assembly. The wrist pin 135, or gudgeon pin, secures the plunger 115 to the connecting rod 130 and provides a bearing for the connecting rod 130 to pivot upon as the plunger 115 moves.

As shown in FIG. 1, the basic fluid end assembly 110 components include a cylinder body 160, a discharge cover 165, valves 170, 172, suction bores 175, 177, springs 180, 182, a valve stop 185, packing 190, a fluid cylinder 195, a cover 197, and an intake 199. The packing 190 and the cylinder body 160 are configured to receive the plunger 115 from the power end assembly 105 side of the hydraulic fracturing pump 100. Insertion and removal of plunger 115 creates the positive and negative pressure loads within the fluid end assembly 110 components that draw low pressure fracking fluid from a reservoir and then turn it into high pressure fracking fluid that is purged through the discharge cover 165 to be received by a well bore. The upstroke of plunger 115 puts pressure on spring 180, which opens valve 170 and permits low pressure fracking fluid to be received through intake 199. Fracking fluid travels through intake 199, then through suction bore 175 and into the main body of the fluid end assembly 110. Cover 197 serves as a stopping point for the plunger 115. Valve stop 185 provides for a stopping point enforcer for the maximum open position of the valve 170, which includes a valve body and valve seat. The downstroke of plunger 115 closes valve 170 and opens valve 172. The now high pressure fracking fluid may travel through open valve 172, fluid cylinder 19, and discharge cover 165 to be sent down a wellbore to create cracks in the deep-rock formations to stimulate flow of natural gas, petroleum, and brine.

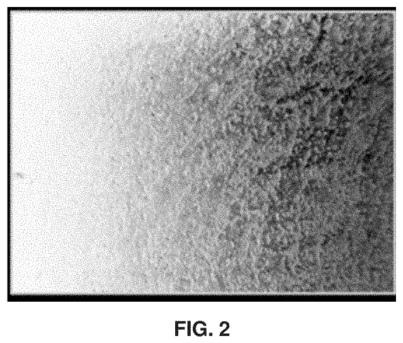

In general, as the fluid end assembly of a hydraulic fracturing pump as shown in FIG. 1 is exposed to high pressure fluids and sand, the components begin to degrade, leading to pitting. FIG. 2 illustrates pitting on a hydraulic fracking pump component as the result of exposure to abrasive and corrosive components of fracking fluid end assembly. Pitting of pump components leads to irregularities in pressure and leads to concentrated areas of stress. For example, as the pits get larger, high pressure fluids collect in the pit, thereby creating specific pressure points, or concentrated areas of stress, that lead to increased degradation as that pit site. Additionally, as the pits and concentrated areas of stress accumulate, overall system pressures can be affected, leading to performance degradation. The accumulation of back pressure or simple wear causes the seals and metal components of the pump to degrade, leading to fluid leakage and pump failure. Additionally, a common failure of hydraulic fracking pump components due to exposure to fracking fluid is fatigue cracking, wherein a component exhibits failure due to excess pressure loading. Fatigue cracking may initiate at the surface of the component or at internal sites. It may be initiated through surface flaws such as the above-described pitting. Also, a common site for cracking is at the intersecting bore within the fluid end assembly. Other components such as valve seats commonly crack inside the valves of the fluid end assembly.

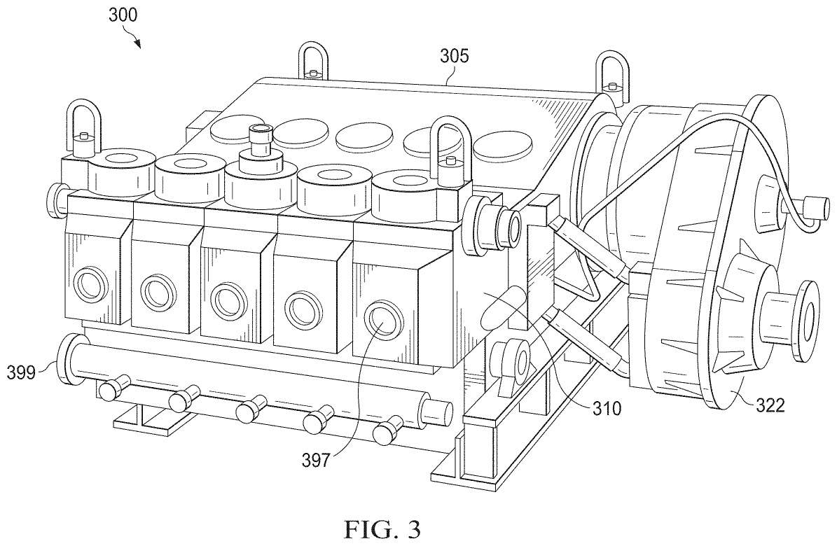

FIG. 3 illustrates a front perspective of a hydraulic fracturing pump 300, according to a specific example embodiment of the disclosure, wherein the hydraulic fracturing pump 300 includes components comprising a resistant steel composition as described herein. Any component of the hydraulic fracturing pump 300 may be made from a resistant steel composition including, but not limited to, a crank case 322, a fluid end assembly 310, a power end assembly 305, a cover 397, and an intake 399.

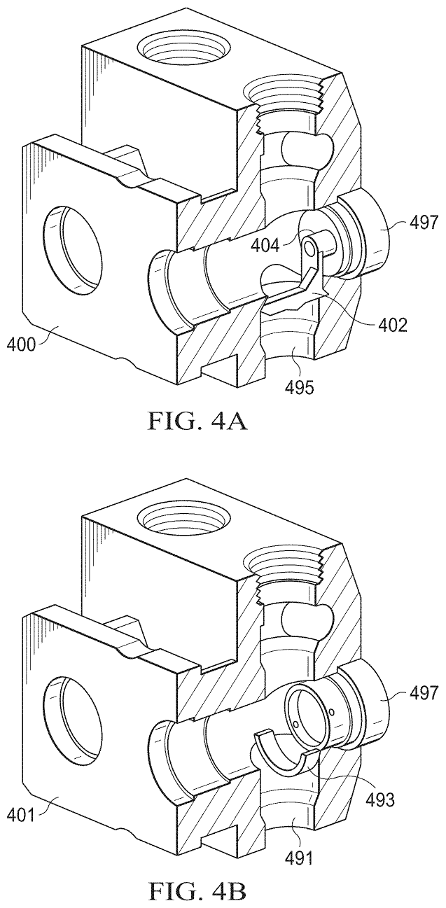

As shown in FIG. 3, hydraulic fracturing pumps 300 include fluid end assemblies 310. Fluid end assemblies can be designed to have various configurations. For example, FIGS. 4A and 4B illustrate perspectives of different fluid end assembly designs according to specific example embodiments of the disclosure. As shown in FIG. 4A, a fluid end assembly 400 may be grooveless and have a valve stop 402 design that locks under a ridge in the fluid cylinder bore 495 and is held in place by a stem 404 in the suction cover 497. The grooveless design may desirably reduce the occurrence of washout or erosion leaking to valve leakage through. The grooveless design may prevent stress cracks that tend to begin formation in grooves. Grooveless designs may permit increased pumping durations, pressures, and flow rates. Additionally, in some embodiments, a fluid end assembly may have a grooved suction bores. As shown in FIG. 4B, a fluid end assembly 401 may include a grooved suction bore 491 that utilizes a wing style vale stop 493 that is locked in place through the grooves 497 that are machined into the suction bore 491. Any component of the fluid end assemblies shown in FIG. 4A and FIG. 4B can be made of a resistant steel composition.

A hydraulic fracking pump component (e.g., a fluid end assembly) composed of a resistant steel composition, hereinafter referenced as a resistant pump component, may have enhanced wear resistance, corrosion resistance, or a combination thereof when compared to a comparable hydraulic fracking pump component composed of carbon alloy steel, hereinafter referenced as a carbon alloy pump component. In some embodiments, a resistant pump component (e.g., a fluid end assembly) may have an extended life span when compared to a carbon alloy pump component. For example, a resistant pump component when compared to a carbon alloy pump component exposed to the same conditions may have an average lifespan that is at least 10% longer, at least 25% longer, or at least 50% longer, or at least 100% longer, or at least 125% longer, or at least 150% longer, or at least 200% longer, or at least 250% longer, or at least 300% longer, or at least 350% longer, or at least 400% longer, or at least 450% longer, or at least 500% longer than that of its carbon alloy counterpart.

A resistant pump component may exhibit less pitting (indicative of corrosion) compared to a carbon alloy pump component exposed to the same conditions. For example, a resistant pump component may exhibit at least 5%, or at least 10%, or at least 15%, or at least 20%, or at least 25%, or at least 30%, or at least 35%, or at least 40%, or at least 45%, or at least 50% less pitting compared to its carbon alloy steel counterpart.

A resistant pump component may exhibit an average lifespan, less pitting, or a combination thereof compared to a carbon alloy pump component.

A resistant pump component may have a manufacturing cost that is less than a counterpart pump component composed of stainless steel, hereinafter referenced as a stainless pump component. For example, a resistant pump component may have a manufacturing cost that is at least 5% less, or at least 10% less, or at least 15% less, or at least 20% less, or at least 30% less, or at least 40% less, or at least 50% less, or at least 60% less than a stainless pump component having comparable life span and/or resistance characteristics. In some embodiments, a resistant pump component may have a manufacturing cost that is at least at least 5% less, or at least 10% less, or at least 15% less, or at least 20% less, or at least 30% less, or at least 40% less, or at least 50% less, or at least 60% less than a stainless pump component when factored as a cost per average working hour. For example, if a stainless pump component has a lifespan of 2000 working hours at a cost of $3 USD per pound. The cost of the stainless pump component is $0.0015 per working hour.

As will be understood by those skilled in the art who have the benefit of the instant disclosure, other equivalent or alternative compositions, devices, and disclosed steel component containing hydraulic fracturing pump systems with a barrier element sand separator can be envisioned without departing from the description contained in this application. Accordingly, the manner of carrying out the disclosure as shown and described is to be construed as illustrative only.

Persons skilled in the art can make various changes in the shape, size, number, and/or arrangement of parts without departing from the scope of the instant disclosure. For example, the position and number of connecting rods can be varied. In some embodiments, plungers can be interchangeable. In addition, the size of a device and/or system can be scaled up or down to suit the needs and/or desires of a practitioner. Each disclosed process, system, method, and method step can be performed in association with any other disclosed method or method step and in any order according to some embodiments. Where the verb “may” appears, it is intended to convey an optional and/or permissive condition, but its use is not intended to suggest any lack of operability unless otherwise indicated. Where open terms such as “having” or “comprising” are used, one of ordinary skill in the art having the benefit of the instant disclosure will appreciate that the disclosed features or steps optionally can be combined with additional features or steps. Such option may not be exercised and, indeed, in some embodiments, disclosed systems, compositions, apparatuses, and/or methods can exclude any other features or steps beyond those disclosed in this application. Elements, compositions, devices, systems, methods, and method steps not recited can be included or excluded as desired or required. Persons skilled in the art can make various changes in methods of preparing and using a composition, device, and/or system of the disclosure.

Also, where ranges have been provided, the disclosed endpoints can be treated as exact and/or approximations as desired or demanded by the particular embodiment. Where the endpoints are approximate, the degree of flexibility can vary in proportion to the order of magnitude of the range. For example, on one hand, a range endpoint of about 50 in the context of a range of about 5 to about 50 can include 50.5, but not 52.5 or 55 and, on the other hand, a range endpoint of about 50 in the context of a range of about 0.5 to about 50 can include 55, but not 60 or 75. In addition, it can be desirable, in some embodiments, to mix and match range endpoints. Also, in some embodiments, each figure disclosed (e.g., in one or more of the examples, tables, and/or drawings) can form the basis of a range (e.g., depicted value+/−about 10%, depicted value+/−about 50%, depicted value+/−about 100%) and/or a range endpoint. With respect to the former, a value of 50 depicted in an example, table, and/or drawing can form the basis of a range of, for example, about 45 to about 55, about 25 to about 100, and/or about 0 to about 100. Disclosed percentages are volume percentages except where indicated otherwise.

All or a portion of a disclosed steel hydraulic fracturing pump can be configured and arranged to be disposable, serviceable, interchangeable, and/or replaceable. These equivalents and alternatives along with obvious changes and modifications are intended to be included within the scope of the present disclosure. Accordingly, the foregoing disclosure is intended to be illustrative, but not limiting, of the scope of the disclosure as illustrated by the appended claims.

The title, abstract, background, and headings are provided in compliance with regulations and/or for the convenience of the reader. They include no admissions as to the scope and content of prior art and no limitations applicable to all disclosed embodiments.

What is claimed is:

1. A resistant steel composition comprising a nickel content from about 1.75% MB to about 5.75% MB.

2. The resistant steel composition of claim 1, further comprising at least one of:
a carbon content from about 0.07% MB to about 0.17% MB;
a manganese content from about 0.3% MB to about 0.6% MB;
a chromium content from about 8% MB to about 10% MB;
a copper content of less than about 0.5% MB;
a sulfur content of less than about 0.02% MB;
a silicon content of less than about 1% MB;
a phosphorous content of less than about 0.04% MB;
a molybdenum content from about 0.5% MB to about 2% MB;
a niobium content from about 0.01% MB to about 0.1% MB;
a vanadium content from about 0.01% MB to about 0.1% MB;
a titanium content from about 0.0001% MB to about 0.1% MB;
a nitrogen content from about 0.02% MB to about 0.07% MB; and
an aluminum content of less than about 0.1% MB.

3. The resistant steel composition of claim 1, wherein the nickel content ranges from about 2.0% MB to about 4.1% MB.

4. The resistant steel composition of claim 1, wherein the resistant steel exhibits from about 5% less to about 50% less pitting than a carbon alloy steel counterpart when exposed to a corrosive.

5. The resistant steel composition of claim 1, wherein the resistant steel exhibits an average lifespan that ranges from at least 10% longer to at least 500% longer than that of a carbon steel alloy counterpart when exposed to a fracking fluid.

6. A hydraulic fracturing pump comprising a fluid end assembly, the fluid end assembly comprising:
a cylinder body configured to receive a respective plunger from a power end assembly;
a suction bore configured to house a valve body, a valve seat, and a spring; and
a spring retainer,
wherein at least one of the cylinder body, the suction bore, and the spring retainer comprises a steel composition comprising:
a nickel content from about 1.75% MB to about 5.75% MB.

7. The hydraulic fracturing pump of claim 6, wherein the steel composition further comprises at least one of:
a carbon content from about 0.07% MB to about 0.17% MB;
a manganese content from about 0.3% MB to about 0.6% MB;
a chromium content from about 8% MB to about 10% MB;
a copper content of less than about 0.5% MB;
a sulfur content of less than about 0.02% MB.
a silicon content of less than about 1% MB;
a phosphorous content of less than about 0.04% MB;
a molybdenum content from about 0.5% MB to about 2% MB;
a niobium content from about 0.01% MB to about 0.1% MB;
a vanadium content from about 0.01% MB to about 0.1% MB;
a titanium content from about 0.0001% MB to about 0.1% MB;
a nitrogen content from about 0.02% MB to about 0.07% MB; and
an aluminum content of less than about 0.1% MB.

8. The hydraulic fracturing pump of claim 6, wherein the nickel content ranges from about 2.0% MB to about 4.1% MB.

9. The hydraulic fracturing pump of claim 6, wherein the fluid end assembly is grooveless.

10. The hydraulic fracturing pump of claim 9, further comprising a suction cover configured to fit into the suction bore and a valve stop that is attached to the suction cover through a stem, the valve stop configured to lock under a ridge in the fluid cylinder bore.

11. The hydraulic fracturing pump of claim 6, wherein the suction bore comprises a groove.

12. The hydraulic fracturing pump of claim 11, further comprising a wing style valve stop configured to lock in place through the groove.

13. A hydraulic fracturing pump comprising a fluid end assembly and a power end assembly, the power end assembly comprising:
a crank shaft;
a frame;
a connecting rod connected to the crank shaft;
a cross head; and
a plunger connected to the connecting rod;
wherein at least one of the crank shaft, the frame, the connecting rod, the cross head, and the plunger comprises a resistant steel composition comprising:
a nickel content from about 1.75% MB to about 5.75% MB.

14. The hydraulic fracturing pump of claim 13, wherein the resistant steel composition further comprises at least one of:
a carbon content from about 0.07% MB to about 0.17% MB;
a manganese content from about 0.3% MB to about 0.6% MB;
a chromium content from about 8% MB to about 10% MB;
a copper content of less than about 0.5% MB;
a sulfur content of less than about 0.02% MB;
a silicon content of less than about 1% MB;
a phosphorous content of less than about 0.04% MB;
a molybdenum content from about 0.5% MB to about 2% MB;
a niobium content from about 0.01% MB to about 0.1% MB;
a vanadium content from about 0.01% MB to about 0.1% MB;
a titanium content from about 0.0001% MB to about 0.1% MB;
a nitrogen content from about 0.02% MB to about 0.07% MB; and
an aluminum content of less than about 0.1% MB.

15. A fluid end block assembly for use in a plunger pump apparatus, the fluid end assembly comprising:
a cylinder body configured to receive a respective plunger from a power end;
a suction bore configured to house a valve body, a valve seat, a spring; and
a spring retainer,
wherein at least one of the cylinder body, the plunger, the suction bore, the valve body, the valve seat, the spring, the spring retainer comprises a resistant steel composition comprising a nickel content from about 1.75% MB to about 5.75% MB.

16. The fluid end block assembly of claim 15, wherein the resistant steel composition further comprises at least one of:
a carbon content from about 0.07% MB to about 0.17% MB;
a manganese content from about 0.3% MB to about 0.6% MB;
a chromium content from about 8% MB to about 10% MB;
a copper content of less than about 0.5% MB;
a sulfur content of less than about 0.02% MB;
a silicon content of less than about 1% MB.
a phosphorous content of less than about 0.04% MB;
a molybdenum content from about 0.5% MB to about 2% MB;
a niobium content from about 0.01% MB to about 0.1% MB;
a vanadium content from about 0.01% MB to about 0.1% MB;
a titanium content from about 0.0001% MB to about 0.1% MB;
a nitrogen content from about 0.02% MB to about 0.07% MB; and
an aluminum content of less than about 0.1% MB.

17. The hydraulic fracturing pump of claim 15, wherein the fluid end assembly is grooveless.

18. The hydraulic fracturing pump of claim 17, further comprising a suction cover configured to fit into the suction bore and a valve stop that is attached to the suction cover through a stem, the valve stop configured to lock under a ridge in the fluid cylinder bore.

19. The hydraulic fracturing pump of claim 15, wherein the suction bore comprises a groove.

20. The hydraulic fracturing pump of claim 19, further comprising a wing style valve stop configured to lock in place through the groove.
